(19) United States
(12) Patent Application Publication
(10) Pub. No.: US 2007/0230479 A1
(43) Pub. Date: Oct. 4, 2007

(54) METHOD AND APPARATUS FOR PROVIDING ADAPTIVE ACKNOWLEDGEMENT SIGNALING IN A COMMUNICATION SYSTEM

(75) Inventor: Zhigang LIU, Santa Clara, CA (US)

Correspondence Address: DITTHAVONG MORI & STEINER, P.C., 918 Prince St., Alexandria, VA, 22314, US

(73) Assignee: Nokia Corporation, Helsinki (FI)

(21) Appl. No.: 11/689,337

(22) Filed: Mar. 21, 2007

Related U.S. Application Data
(60) Provisional application No. 60/788,124, filed on Mar. 31, 2006.

(51) Int. Cl. H04L 12/56

(52) U.S. Cl. 370/395.52

(57) ABSTRACT

An approach is provided for adaptive acknowledgement signaling. Data is received over a communication link. Condition of the communication link is determined. Determining treatment of acknowledgement signaling based on the determined link condition.

### RELATED APPLICATIONS

This application claims the benefit of the earlier filing date under 35 U.S.C. §119(e) of U.S. Provisional Application Ser. No. 60/788,124 filed Mar. 31, 2006, entitled “Method and Apparatus for Providing Adaptive Acknowledgement Signaling in a Communication System,” the entirety of which are incorporated by reference.

### BACKGROUND

Radio communication systems, such as cellular systems (e.g., spread spectrum systems (such as Code Division Multiple Access (CDMA) networks), and Time Division Multiple Access (TDMA) networks), provide users with the convenience of mobility along with a rich set of services and features. This convenience has spawned significant adoption by an ever growing number of consumers as an accepted mode of communication for business and personal uses in terms of communicating voice and data (including textual and graphical information).

The use of acknowledgements (ACKs) and/or negative acknowledgements (NACKs) are required to indicate whether data has been received successfully, or unsuccessfully. This mechanism is executed by a transmitter and a receiver to notify the transmitter whether the data has to be retransmitted. This mechanism can also support flow control of the data exchange between the transmitter and receiver, whereby the receiver conveys to the transmitter that the receiver is ready to receive more data. In a single carrier system, the ACK/NACK signaling can be implemented in a relatively straightforward manner. Radio communication systems are prone to latency and delay, which can interfere with acknowledgement signaling and can even aggravate a congested condition.

### Some Exemplary Embodiments

Therefore, there is a need for an approach to provide more efficient acknowledgement signaling.

According to one embodiment of the present invention, a method comprises receiving data over a communication link. The method also comprises determining condition of the communication link. The method further comprises determining treatment of acknowledgement signaling based on the determined link condition. The treatment includes either skipping or omitting acknowledgement signaling.

According to another embodiment of the present invention, an apparatus comprises an adaptive acknowledgement module configured to determine condition of a communication link in response to receiving data over the communication link. The adaptive acknowledgement module is configured to determine treatment of acknowledgement signaling based on the determined link condition. The treatment includes skipping or omitting acknowledgement signaling.

According to another embodiment of the present invention, an apparatus comprises means for receiving data over a communication link. The apparatus also comprises means for determining condition of the communication link and for determining treatment of acknowledgement signaling based on the determined link condition, wherein the treatment includes skipping or omitting acknowledgement signaling.

According to yet another embodiment of the present invention, a method comprises transmitting data over a communication link to a receiver, wherein the receiver is configured to determine condition of the communication link and to determine treatment of acknowledgement signaling based on the determined link condition. The method also comprises selectively receiving an acknowledgement message in response to the transmitted data, wherein the treatment includes skipping or discarding the acknowledgement message.

Still other aspects, features, and advantages of the embodiments of the invention are readily apparent from the following detailed description, simply by illustrating a number of particular embodiments and implementations, including the best mode contemplated for carrying out the embodiments of the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings and in which like reference numerals refer to similar elements and in which:

FIG. 1 is a diagram of a communication system capable of providing adaptive acknowledgement signaling, in accordance with an embodiment of the invention;

FIG. 2 is a flowchart of a process for providing adaptive acknowledgement signaling, in accordance with an embodiment of the invention;

FIG. 3 is a diagram of an access terminal including an adaptive acknowledgement signaling module, according to an embodiment of the invention;

FIG. 4 is a diagram of a radio communication system capable of providing adaptive acknowledgement signaling, in accordance with an embodiment of the invention;

FIGS. 5A-5C are flowcharts of various processes for providing adaptive acknowledgement signaling, in accordance with certain embodiments of the invention;

FIG. 6 is a diagram of hardware that can be used to implement various embodiments of the invention;

FIGS. 7A and 7B are diagrams of different cellular mobile phone systems capable of supporting various embodiments of the invention;

FIG. 8 is a diagram of exemplary components of a mobile station capable of operating in the systems of FIGS. 7A and 7B, according to an embodiment of the invention; and

FIG. 9 is a diagram of an enterprise network capable of supporting the processes described herein, according to an embodiment of the invention.

### DESCRIPTION OF PREFERRED EMBODIMENTS

An apparatus, method, and software for providing acknowledgement (ACK/NACK) signaling over a data network are described. In the following description, for the purposes of explanation, numerous specific details are set forth in order to provide a thorough understanding of the invention. It is apparent, however, to one skilled in the art that the invention may be practiced without these specific details or with an equivalent arrangement. In other instances, well-known structures and devices are shown in block diagram form in order to avoid unnecessarily obscuring the invention.

Although the invention is discussed with respect to a radio communication network (such as a cellular system) and the Transmission Control Protocol (TCP), it is recognized by one of ordinary skill in the art that the invention has applicability to any type of communication systems, including wired systems, as well as other equivalent transport protocols.

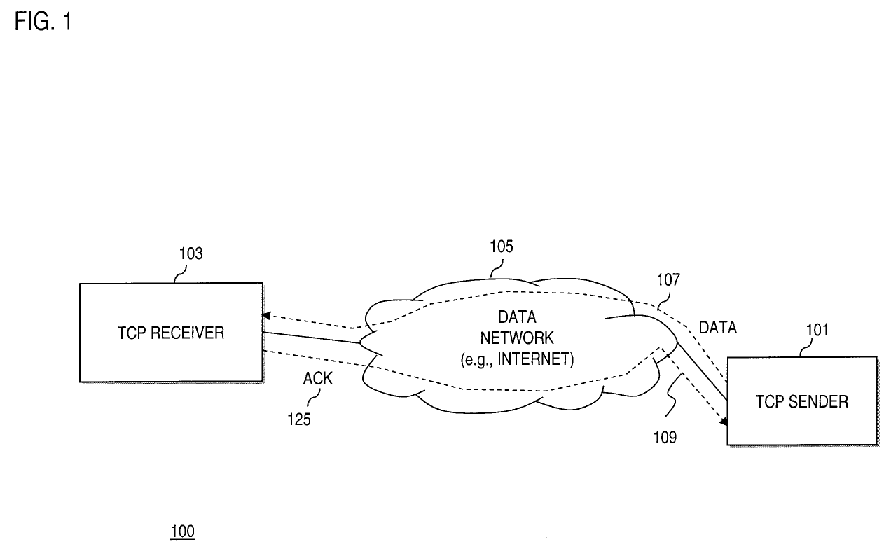

FIG. 1 is a diagram of a communication system capable of providing adaptive acknowledgement signaling, in accordance with an embodiment of the invention. For the purposes of illustration, a communication system 100 includes a sender 101 and a receiver 103 communicating over a data network 105. As more fully described below, the sender 101 and the receiver 103 can utilize a variety of protocols to communicate; such protocols include a transport layer protocol—e.g., Transmission Control Protocol (TCP). Consequently, in this exemplary scenario, the sender 101 is considered a TCP sender, while the receiver 103 is denoted a TCP receiver. As shown in FIG. 1, a TCP receiver 103 communicates with a TCP sender 101 over a data network 105 over communication links 107 and 109. The TCP sender 101 delivers data via link 107 to the TCP receiver 103, which acknowledges the receipt of such data over link 109. Accordingly to one embodiment of the invention, the communication links 107 and 109 are logical and can be transport over common physical facilities. The acknowledgement signal mechanism, according to exemplary embodiments, is adaptive in that the mechanism intelligently determines whether acknowledgements can be sent, skipped, or simply discarded (or omitted) based on the state of the communication link through the data network 105.

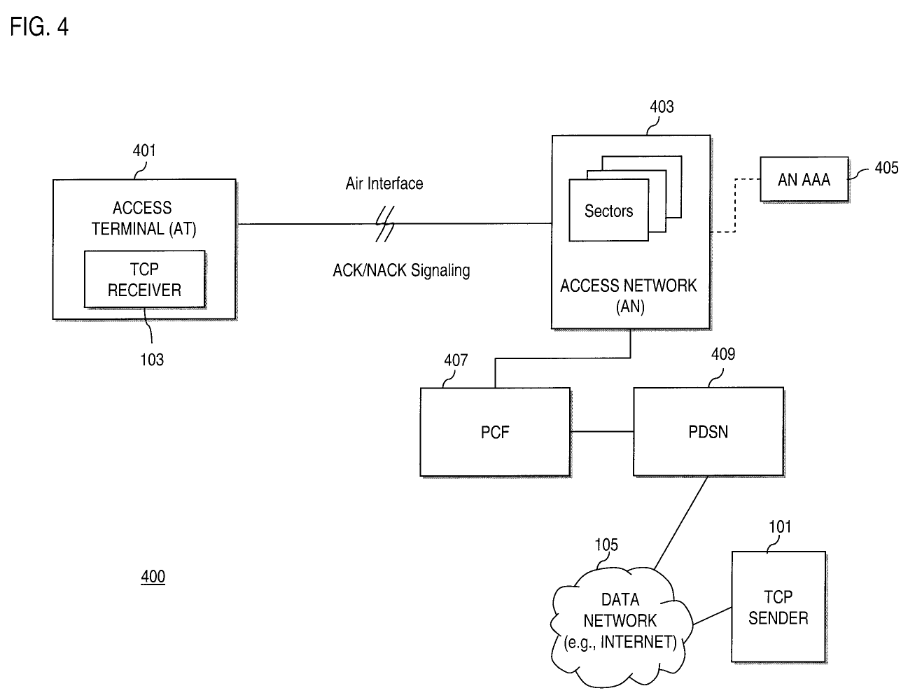

It is recognized that the reverse link of 1×EV-DO (1× Evolution Data-Only (or Data-Optimized)) rev 0 can possess low and fluctuating bit rate; such an exemplary architecture is shown in FIG. 4. This can cause large delay and delay jitter of TCP ACKs when an access terminal (AT) is downloading data on the forward direction from the network 105. The result is that the download bit rate on the forward direction is significantly limited (i.e., cannot achieve the maximum rate allowed otherwise), and in some cases the download even stalls. More seriously, the delay is sometime so long that the TCP sender 101 on the remote endpoint eventually “times out” and “starts re-transmission” (which is redundant and waste bandwidth). That in turn triggers the TCP receiver 103 in the AT 401 to send more ACKs 125, which will lead to more delay due to the already congested reverse link.

The invention, according to various embodiments, addresses the above acknowledgement signaling problems by applying a mechanism for the TCP receiver 103 to behave more intelligently in providing acknowledgements. Essentially, the TCP receiver 103 adapts to the underlying reverse link and reduce the number of ACKs when the link condition is bad (i.e., low bit rate and long delay). This approach can be implemented locally without standardization, and can be applied, in an exemplary embodiment, to any 1×EV-DO AT.

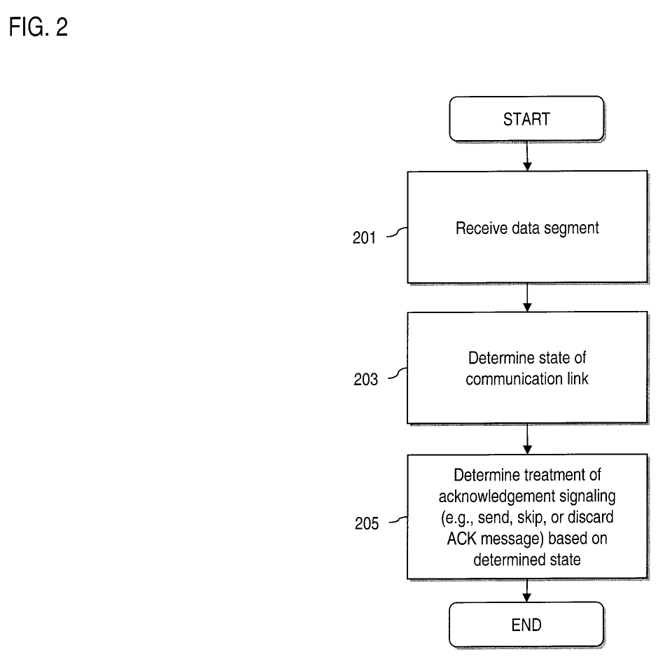

FIG. 2 is a flowchart of a process for providing adaptive acknowledgement signaling, in accordance with an embodiment of the invention. Continuing with the exemplary system 100, the sender 101 has data queued for transmission to the receiver 103 over the data network 105. As dictated by the application, the sender transmits data using a TCP/IP protocol stack, for example. Data is received, per step 201, by the TCP receiver 103 over the communication link 107 that is established over the data network 105; this communication link 107 supports a TCP session.

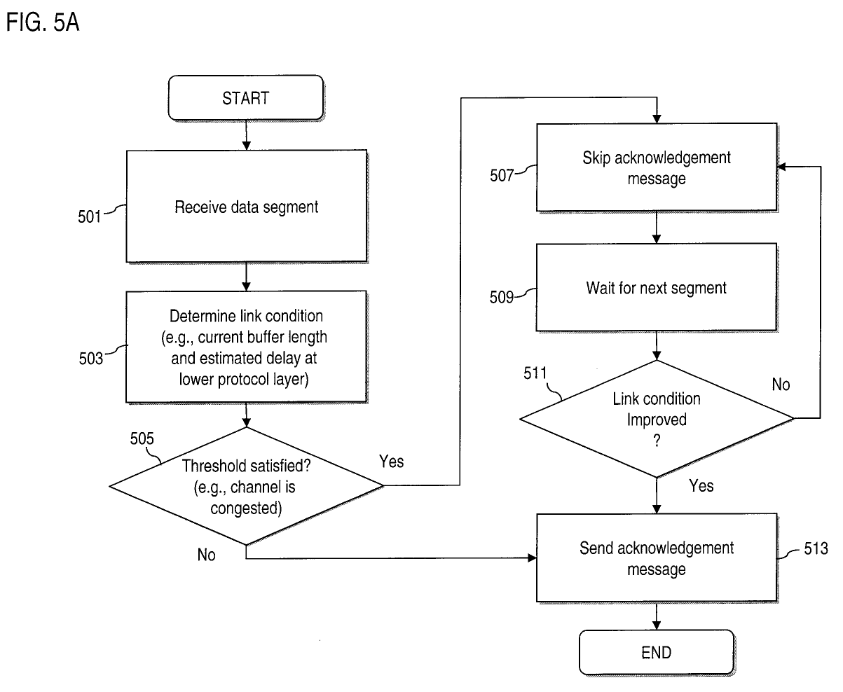

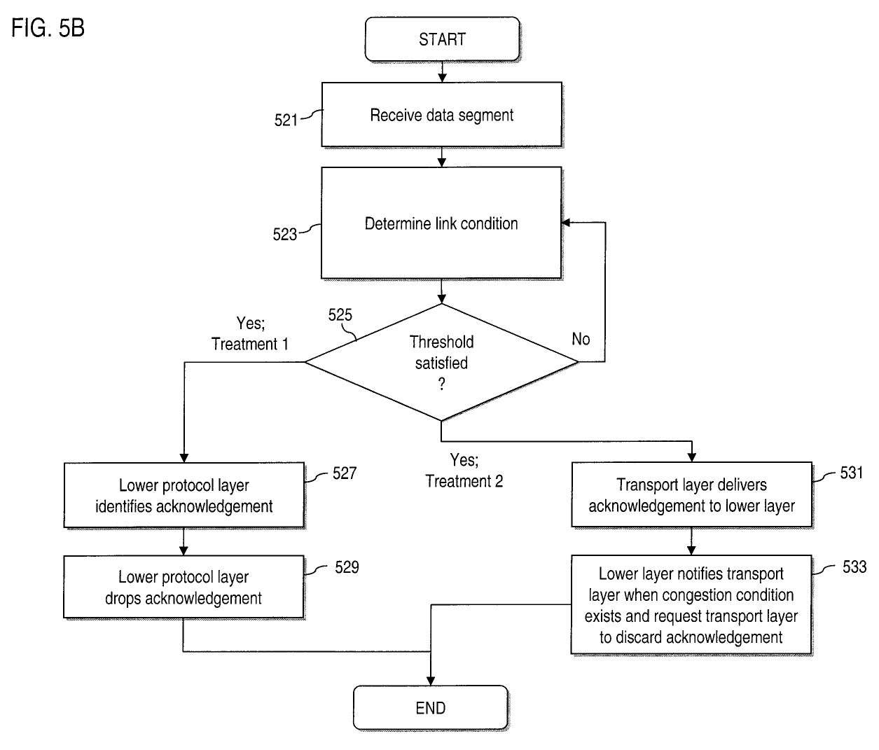

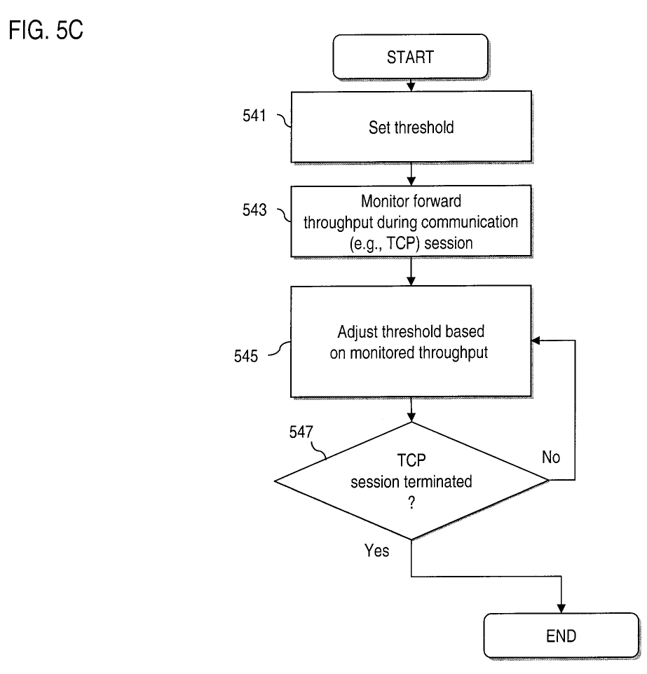

In step 203, the TCP receiver 103 determines the state of the communication link 109 (i.e., acknowledgement channel). As mentioned, the logical links 107 and 109 can be supported over the same physical channels. Hence, the determination of the state information can pertain to link 107, in such case. State information can include one or more parameters indicative of the quality of the link, such as signal-to-noise (S/N), bit error rate (BER), signal strength, data rate, throughput, latency, low layer protocol delay, buffer length, etc. Upon determination of the state of the communication link 109, the TCP receiver then determines, as in step 205, the appropriate treatment for acknowledgement signaling; for example, the TCP ACK message can be sent if the state of the link 109 is favorable (e.g., low BER). Alternatively, the ACK message can be skipped or discarded (i.e., omitted). Other details of this dynamic acknowledgement signaling approach are described below with respect to FIGS. 5A-5C.

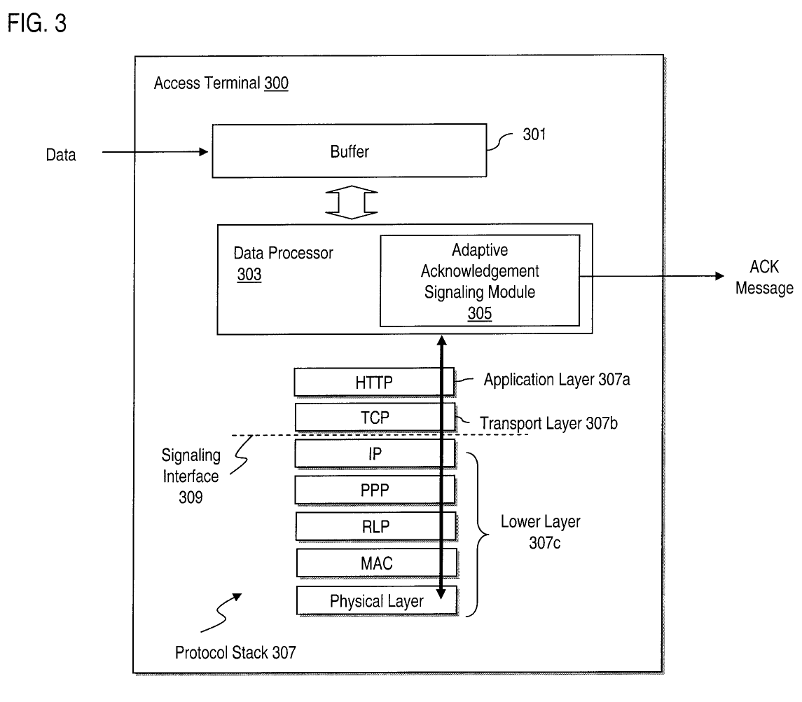

FIG. 3 is a diagram of an access terminal including an adaptive acknowledgement signaling module, according to an embodiment of the invention. In this example, an access terminal 300 includes a data buffer 301 configured to store data (e.g., packets) for transmission. An adaptive acknowledgement signaling module 305 including an exemplary data flow supporting adaptive acknowledgement signaling. The data is retrieved by a data processor 303 for conditioning to be transmitted according to various communication protocols (i.e., protocol stack) 307, which according to one embodiment, provides for an application layer 307a, a transport layer 307b, and a lower layer 307c. The lower layer 307c, in an exemplary embodiment, can be the Internet Protocol (IP), point-to-point protocol (PPP), radio link protocol (RLP), medium access control (MAC) layer, and physical layer.

In this layered approach, each protocol layer usually communicates with another corresponding layer. In this example, the transport layer 307b employs Transmission Control Protocol (TCP). Using TCP, applications on networked hosts can create connections to one another, over which they can exchange streams of data using stream sockets. The protocol provides reliable and in-order delivery of data from sender to receiver. TCP also distinguishes data for multiple connections by concurrent applications (e.g., Web server and e-mail server) running on the same host.

TCP supports a variety of application protocols (such as the HyperText Transfer Protocol (HTTP)) and associated applications, including the World Wide Web, e-mail and Secure Shell. By way of example, TCP utilizes the Internet Protocol (IP) in support of HTTP. Applications often need reliable pipe-like connections to each other, whereas the Internet Protocol does not provide such streams, but rather only best effort delivery (i.e., unreliable packets).

When receiving a TCP segment, the adaptive acknowledgement signaling module 305 can determine the communication link state information by, for example, checking the current length of the buffer 301 and/or estimate delay associated with the communication protocols at the lower layer 307c. As noted, the lower layer 307c can be the RLP (Radio Link Protocol) as specified in 1×EV-DO. If the estimated delay is long, the TCP receiver 103 may choose not to send ACK for the current segment. Instead, the TCP receiver 103 can wait for the next TCP segment and then send an ACK (for the next TCP segment), if (and when) the link condition improves.

Essentially, the TCP receiver 103 conditionally skips ACKs, and thus reduces the number of ACKs to be transmitted when the reverse link is congested.

Some observations are provided regarding the adaptive acknowledgement signaling performed by the module 307. The TCP receiver 103 can acquire the lower layer delay and buffer length information (or other communication link state information) by various means; for example, a signaling interface 309 can be developed between the TCP layer and the lower protocol layer 307c to pass on the information. Also, the adaptive scheme can be made to be proactive—i.e., some “safe margin” should usually be applied avoid the ACK congestion problem in the first place, instead of correcting the problem after it occurs. These state parameters can be assigned a threshold value whereby the adaptive scheme is triggered. This thresholding approach is more fully described in FIGS. 5A-5C.

Additionally, it is noted that the exact threshold (e.g., estimated delay in milliseconds (ms) or buffer length at the lower layer 307c) for triggering the TCP receiver 103 to skip ACKs can be set depending on the particular application (e.g., network configuration and conditions). Also, the threshold may be adjusted over the lifetime of a TCP connection, and thus, is a dynamic process. The approach provides for the TCP receiver 103 to determine a threshold such that the downloading throughput on the forward direction is maximized. In particular, the TCP receiver 103 need not totally eliminate local buffering delay for each TCP ACK, but performs the ACK skipping to the extent such that congestion is not aggravated.

Moreover, it is noted that a smaller number of ACKs does not necessarily mean a larger download throughput. For example, skipping ACKs during slow start phase of a TCP connection would actually prevent the TCP sender 101 from increasing its transmission rate at a faster pace. Furthermore, TCP ACKs are subject to packet loss. A smaller number of ACKs (or equivalently a larger time spacing between ACKs) can indicate a longer time is needed for the TCP sender 101 to receive the next ACK if the previous ACK is lost. This extra waiting time may block the TCP sender 101 from transmission during that period of time.

Furthermore, there are other certain circumstances in which the TCP receiver 103 may not want to skip an ACK. For example, the TCP receiver 103 may want to use duplicate ACK feature to signal an out-of-order segment arrival or the receiver 103 may want to send a TCP ACK with options (e.g. SACK (Selective Acknowledgement)). In those cases, the TCP may choose not to skip the ACK.

As mentioned, the adaptive acknowledgement signaling approach can be utilized in various communications, such as a radio network, as next described.

FIG. 4 is a diagram of a radio communication system capable of providing adaptive acknowledgement signaling, in accordance with an embodiment of the invention. By way of example, a radio network 400 operates according to the Third Generation Partnership Project 2 (3GPP2) standard for supporting High Rate Packet Data (HRPD). The radio network 400 includes one or more access terminals (ATs) of which one AT 401 is shown in communication with an access network (AN) 403 over an air interface. In cdma2000 systems, the AT 401 is equivalent to a mobile station, and the access network 403 is equivalent to a base station. The AT 401 is a device that provides data connectivity to a user. For example, the AT 401 can be connected to a computing system, such as a personal computer, a personal digital assistant, and etc. or a data service enabled cellular handset. As shown, in this scenario, the AT 401 behaves as a TCP receiver 101 with adaptive acknowledgement signaling capabilities. The AT 401 communicates with the TCP sender 101 via the access network 403.

The AN 403 is a network equipment that provides data connectivity between a packet switched data network 105, such as the global Internet and the AT 401. The AN 403 communicates with a Packet Data Service Node (PDSN) 409 via a Packet Control Function (PCF) 407. Either the AN 403 or the PCF 407 provides a SC/MM (Session Control and Mobility Management) function, which among other functions includes storing of HRPD session related information, performing the terminal authentication procedure to determine whether an AT 401 should be authenticated when the AT 401 is accessing the radio network, and managing the location of the AT 401. The PCF 407 is further described in 3GPP2 A.S0001-A v2.0, entitled “3GPP2 Access Network Interfaces Interoperability Specification,” June 2001, which is incorporated herein by reference in its entirety. Also, a more detailed description of the HRPD is provided in TSG-C.S0024-IS-856, entitled “cdma2000 High Rate Packet Data Air Interface Specification,” which is incorporated herein by reference in its entirety.

In addition, the AN 403 communicates with an AN-AAA (Authentication, Authorization and Accounting entity) 405, which provides terminal authentication and authorization functions for the AN 403.

Both the cdma2000 1×EV-DV (Evolution—Data and Voice) and 1×EV-DO (Evolution—Data Optimized) air interface standards specify a packet data channel for use in transporting packets of data over the air interface on the forward link and the reverse link. A wireless communication system may be designed to provide various types of services. These services may include point-to-point services, or dedicated services such as voice and packet data, whereby data is transmitted from a transmission source (e.g., a base station) to a specific recipient terminal. Such services may also include point-to-multipoint (i.e., multicast) services, or broadcast services, whereby data is transmitted from a transmission source to a number of recipient terminals.

In the multiple-access wireless communication system, communications between users are conducted through one or more AT(s) and a user (access terminal) 401 on one wireless station communicates to a second user on a second wireless station by conveying information signal on a reverse link to a base station. The AN 403 receives the information signal and conveys the information signal on a forward link to the AT station 401. The AN 403 then conveys the information signal on a forward link to the station. The forward link refers to transmissions from an AN 403 to the AT 401, and the reverse link refers to transmissions from the AT 401 to the AN 403. The AN 403 receives the data from the first user on the wireless station 401 on a reverse link, and routes the data through a public switched telephone network (PSTN) (not shown) to the second user on a landline station. In many communication systems, e.g., IS-95, Wideband CDMA (WCDMA), and IS-2000, the forward link and the reverse link are allocated separate frequencies.

FIGS. 5A-5C are flowcharts of various processes for providing adaptive acknowledgement signaling, in accordance with certain embodiments of the invention.

As seen in FIG. 5A, when a TCP receiver 103 receives a data segment (per step 501), the adaptive acknowledgement module 305 determines the link condition by examining, for example, the current buffer length and/or estimated delay at a lower protocol layer, as in step 503. The receiver 103 then determines whether a threshold value (i.e., link condition threshold) associated with the buffer length and/or delay is reached or otherwise satisfied—i.e., indicative of link congestion. If the link condition threshold is satisfied, the adaptive acknowledgement module 305 skips, per step 507, the transmission of an acknowledgement (ACK) message, and waits for the nest segment (per step 509). The waiting period or state can be set until the link condition improves (as determined in step 511) or the module 305 times out. If the link condition is determined to have improved, the acknowledgement message is sent, as in step 513.

Returning to the threshold decision step 505, if the module 305 determines that the threshold is not reached, an acknowledgement message is sent, as in the normal TCP acknowledgement procedure.

Alternatively, other treatments for acknowledgement signaling can be performed. For instance, the adaptive acknowledgement signaling module 305 can involve the lower protocol layers in the decision whether received data needs to be acknowledged. In FIG. 5B, as in the steps 501-505 of FIG. 5A, a data segment is received and link state or condition is determined. Upon satisfaction of the threshold, one of two treatment options is provided in this exemplary scenario. In one treatment (denoted as “Treatment 1”), the lower layer 307c is responsible for identifying and dropping (per steps 527 and 529) a TCP ACK, if the transmission buffer 301 is too long or the TCP receiver 103 determines that transmitting all ACKs in the buffer 301 will lead to some ACKs being late on the remote TCP sender 101.

For example, assuming ACK 1, 2, 3, and 4 are buffered by the lower layer 307 (with ACK 1 being the oldest), if the lower layer 307c determines that transmitting all four ACKs will make some of them (e.g., ACK 3 and ACK 4) late, the TCP receiver 103 can discard ACK 1 or 2 and transmit 3 and 4 only. On the other hand, if all 4 ACKs in queue can be transmitted in time, the lower layer 307c will not discard any ACKs.

The above Treatment 1 approach can be used, for example, if the TCP stack cannot be changed to implement the adaptive acknowledgement scheme, or it is difficult or impossible to pass delay information between the lower layer 307c and the transport layer transport layer 307c307b. This approach can require more logic since the lower layer 307c has to identify TCP ACK packets to the transport layer 307b (which may not be aware of the packet dropping). To address this, partial TCP logic can be implemented in the lower layer 307c; in the alternative, the transport layer 307b can make the decision and then mark each ACK packet before it is delivered to the lower layer 307c (indicating it is an ACK and whether it can be dropped).

In Treatment 2, the TCP layer 307b generates ACKs as usual and delivers them to the lower layer 307c (as in step 531). The lower layer 307c then notifies the transport layer 307c when there is congestion (per step 533), and inquires with the transport layer 307c which ACKs can be discarded. It is noted that if data other than TCP ACKs is also transmitted over the reverse link, the lower layer 307c can give higher priority to TCP ACKs.

As noted, the thresholding approach whereby the adaptive acknowledgement signaling is triggered is a dynamic process. In step 541 (as seen in FIG. 5C), the link condition threshold is set; this value can be a historical value or a value that is determined or predicted by the receiver 103. The adaptive acknowledgement module 305 can monitor the forward throughput (i.e., throughput associated with the received data) during the communication session (e.g., TCP session), per step 543. At this point, the module 305 can adjust the threshold based on the monitored throughput, as in step 545. Next, in step 547, the module 305 determines whether the communication session is still active. If the session (e.g., TCP session) remains active, the steps 543 and 545 of monitoring and adjustment are repeated. Otherwise, the process ends.

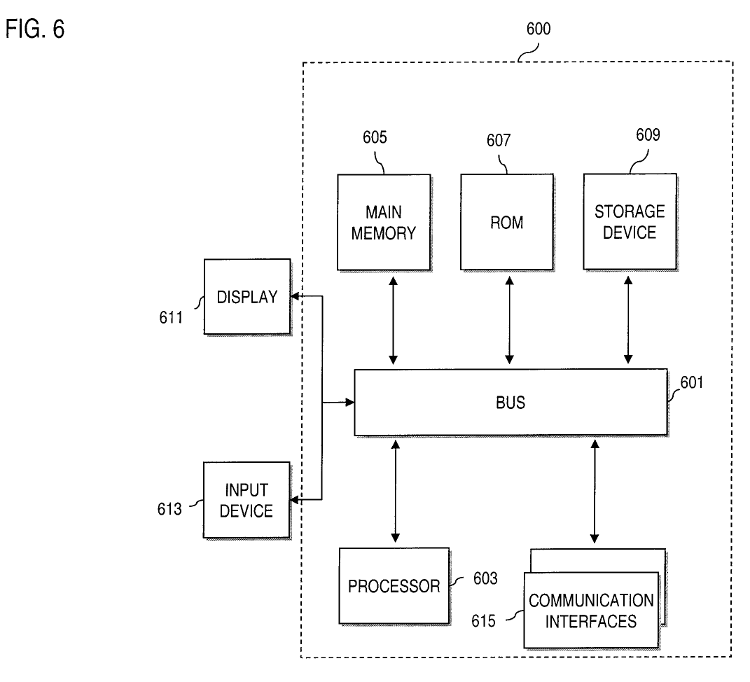

One of ordinary skill in the art would recognize that the processes for providing acknowledgement signaling may be implemented via software, hardware (e.g., general processor, Digital Signal Processing (DSP) chip, an Application Specific Integrated Circuit (ASIC), Field Programmable Gate Arrays (FPGAs), etc.), firmware, or a combination thereof. Such exemplary hardware for performing the described functions is detailed below with respect to FIG. 6.

FIG. 6 illustrates exemplary hardware upon which various embodiments of the invention can be implemented. A computing system 600 includes a bus 601 or other communication mechanism for communicating information and a processor 603 coupled to the bus 601 for processing information. The computing system 600 also includes main memory 605, such as a random access memory (RAM) or other dynamic storage device, coupled to the bus 601 for storing information and instructions to be executed by the processor 603. Main memory 605 can also be used for storing temporary variables or other intermediate information during execution of instructions by the processor 603. The computing system 600 may further include a read only memory (ROM) 607 or other static storage device coupled to the bus 601 for storing static information and instructions for the processor 603. A storage device 609, such as a magnetic disk or optical disk, is coupled to the bus 601 for persistently storing information and instructions.

The computing system 600 may be coupled via the bus 601 to a display 611, such as a liquid crystal display, or active matrix display, for displaying information to a user. An input device 613, such as a keyboard including alphanumeric and other keys, may be coupled to the bus 601 for communicating information and command selections to the processor 603. The input device 613 can include a cursor control, such as a mouse, a trackball, or cursor direction keys, for communicating direction information and command selections to the processor 603 and for controlling cursor movement on the display 611.

According to various embodiments of the invention, the processes described herein can be provided by the computing system 600 in response to the processor 603 executing an arrangement of instructions contained in main memory 605. Such instructions can be read into main memory 605 from another computer-readable medium, such as the storage device 609. Execution of the arrangement of instructions contained in main memory 605 causes the processor 603 to perform the process steps described herein. One or more processors in a multi-processing arrangement may also be employed to execute the instructions contained in main memory 605. In alternative embodiments, hard-wired circuitry may be used in place of or in combination with software instructions to implement the embodiment of the invention. In another example, reconfigurable hardware such as Field Programmable Gate Arrays (FPGAs) can be used, in which the functionality and connection topology of its logic gates are customizable at run-time, typically by programming memory look up tables. Thus, embodiments of the invention are not limited to any specific combination of hardware circuitry and software.

The computing system 600 also includes at least one communication interface 615 coupled to bus 601. The communication interface 615 provides a two-way data communication coupling to a network link (not shown). The communication interface 615 sends and receives electrical, electromagnetic, or optical signals that carry digital data streams representing various types of information. Further, the communication interface 615 can include peripheral interface devices, such as a Universal Serial Bus (USB) interface, a PCMCIA (Personal Computer Memory Card International Association) interface, etc.

The processor 603 may execute the transmitted code while being received and/or store the code in the storage device 609, or other non-volatile storage for later execution. In this manner, the computing system 600 may obtain application code in the form of a carrier wave.

The term “computer-readable medium” as used herein refers to any medium that participates in providing instructions to the processor 603 for execution. Such a medium may take many forms, including but not limited to non-volatile media, volatile media, and transmission media. Non-volatile media include, for example, optical or magnetic disks, such as the storage device 609. Volatile media include dynamic memory, such as main memory 605. Transmission media include coaxial cables, copper wire and fiber optics, including the wires that comprise the bus 601. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the invention may initially be borne on a magnetic disk of a remote computer. In such a scenario, the remote computer loads the instructions into main memory and sends the instructions over a telephone line using a modem. A modem of a local system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

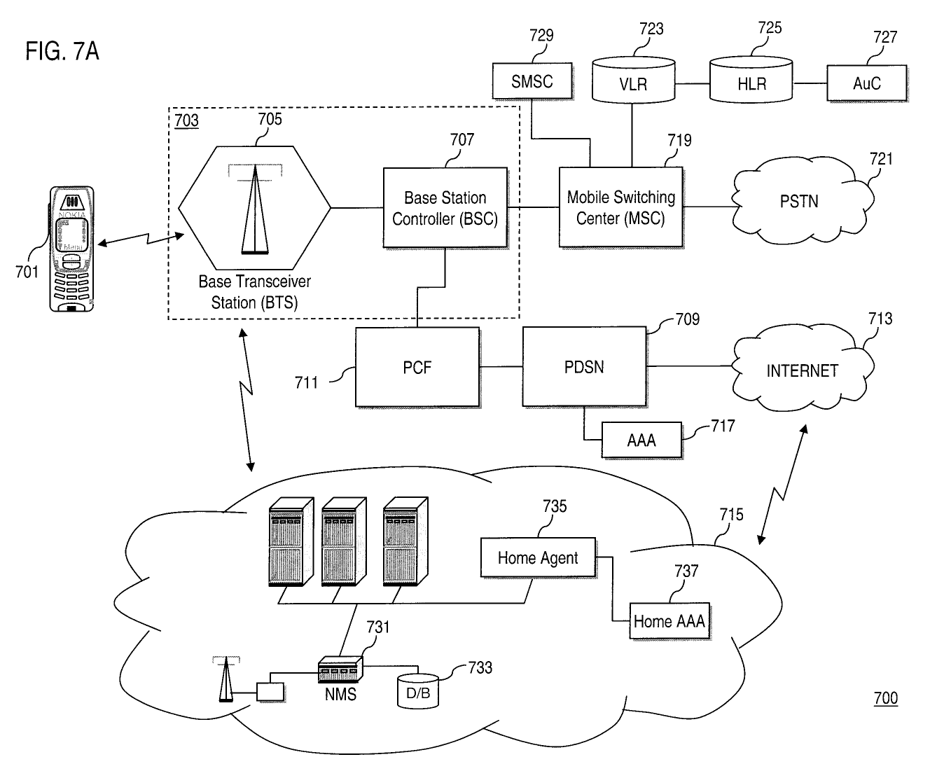

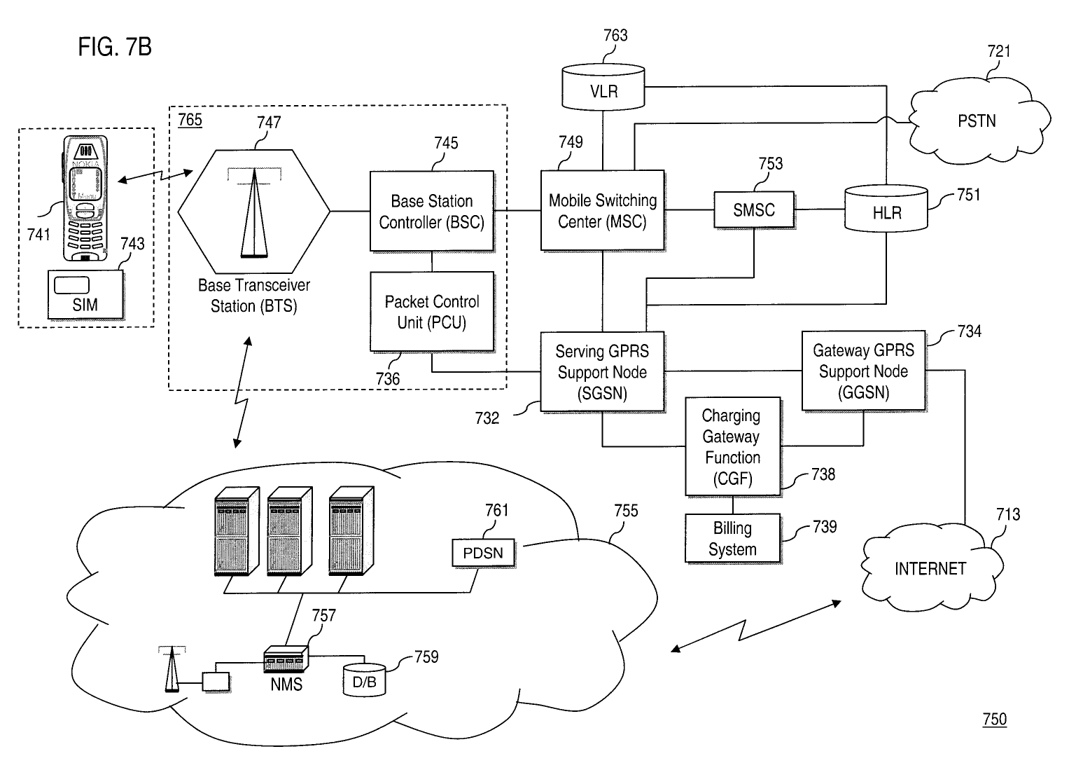

FIGS. 7A and 7B are diagrams of different cellular mobile phone systems capable of supporting various embodiments of the invention. FIGS. 7A and 7B show exemplary cellular mobile phone systems each with both mobile station (e.g., handset) and base station having a transceiver installed (as part of a Digital Signal Processor (DSP)), hardware, software, an integrated circuit, and/or a semiconductor device in the base station and mobile station). By way of example, the radio network supports Second and Third Generation (2G and 3G) services as defined by the International Telecommunications Union (ITU) for International Mobile Telecommunications 2000 (IMT-2000). For the purposes of explanation, the carrier and channel selection capability of the radio network is explained with respect to a cdma2000 architecture. As the third-generation version of IS-95, cdma2000 is being standardized in the Third Generation Partnership Project 2 (3GPP2).

A radio network 700 includes mobile stations 701 (e.g., handsets, terminals, stations, units, devices, or any type of interface to the user (such as “wearable” circuitry, etc.)) in communication with a Base Station Subsystem (BSS) 703. According to one embodiment of the invention, the radio network supports Third Generation (3G) services as defined by the International Telecommunications Union (ITU) for International Mobile Telecommunications 2000 (IMT-2000).

In this example, the BSS 703 includes a Base Transceiver Station (BTS) 705 and Base Station Controller (BSC) 707. Although a single BTS is shown, it is recognized that multiple BTSs are typically connected to the BSC through, for example, point-to-point links. Each BSS 703 is linked to a Packet Data Serving Node (PDSN) 709 through a transmission control entity, or a Packet Control Function (PCF) 711. Since the PDSN 709 serves as a gateway to external networks, e.g., the Internet 713 or other private consumer networks 715, the PDSN 709 can include an Access, Authorization and Accounting system (AAA) 717 to securely determine the identity and privileges of a user and to track each user's activities. The network 715 comprises a Network Management System (NMS) 731 linked to one or more databases 733 that are accessed through a Home Agent (HA) 735 secured by a Home AAA 737.

Although a single BSS 703 is shown, it is recognized that multiple BSSs 703 are typically connected to a Mobile Switching Center (MSC) 719. The MSC 719 provides connectivity to a circuit-switched telephone network, such as the Public Switched Telephone Network (PSTN) 721. Similarly, it is also recognized that the MSC 719 may be connected to other MSCs 719 on the same network 700 and/or to other radio networks. The MSC 719 is generally collocated with a Visitor Location Register (VLR) 723 database that holds temporary information about active subscribers to that MSC 719. The data within the VLR 723 database is to a large extent a copy of the Home Location Register (HLR) 725 database, which stores detailed subscriber service subscription information. In some implementations, the HLR 725 and VLR 723 are the same physical database; however, the HLR 725 can be located at a remote location accessed through, for example, a Signaling System Number 7 (SS7) network. An Authentication Center (AuC) 727 containing subscriber-specific authentication data, such as a secret authentication key, is associated with the HLR 725 for authenticating users. Furthermore, the MSC 719 is connected to a Short Message Service Center (SMSC) 729 that stores and forwards short messages to and from the radio network 700.

During typical operation of the cellular telephone system, BTSs 705 receive and demodulate sets of reverse-link signals from sets of mobile units 701 conducting telephone calls or other communications. Each reverse-link signal received by a given BTS 705 is processed within that station. The resulting data is forwarded to the BSC 707. The BSC 707 provides call resource allocation and mobility management functionality including the orchestration of soft handoffs between BTSs 705. The BSC 707 also routes the received data to the MSC 719, which in turn provides additional routing and/or switching for interface with the PSTN 721. The MSC 719 is also responsible for call setup, call termination, management of inter-MSC handover and supplementary services, and collecting, charging and accounting information. Similarly, the radio network 700 sends forward-link messages. The PSTN 721 interfaces with the MSC 719. The MSC 719 additionally interfaces with the BSC 707, which in turn communicates with the BTSs 705, which modulate and transmit sets of forward-link signals to the sets of mobile units 701.

As shown in FIG. 7B, the two key elements of the General Packet Radio Service (GPRS) infrastructure 750 are the Serving GPRS Supporting Node (SGSN) 732 and the Gateway GPRS Support Node (GGSN) 734. In addition, the GPRS infrastructure includes a Packet Control Unit (PCU) 736 and a Charging Gateway Function (CGF) 738 linked to a Billing System 739. A GPRS the Mobile Station (MS) 741 employs a Subscriber Identity Module (SIM) 743.

The PCU 736 is a logical network element responsible for GPRS-related functions such as air interface access control, packet scheduling on the air interface, and packet assembly and re-assembly. Generally the PCU 736 is physically integrated with the BSC 745; however, it can be collocated with a BTS 747 or a SGSN 732. The SGSN 732 provides equivalent functions as the MSC 749 including mobility management, security, and access control functions but in the packet-switched domain. Furthermore, the SGSN 732 has connectivity with the PCU 736 through, for example, a Fame Relay-based interface using the BSS GPRS protocol (BSSGP). Although only one SGSN is shown, it is recognized that that multiple SGSNs 732 can be employed and can divide the service area into corresponding routing areas (RAs). A SGSN/SGSN interface allows packet tunneling from old SGSNs to new SGSNs when an RA update takes place during an ongoing Personal Development Planning (PDP) context. While a given SGSN may serve multiple BSCs 745, any given BSC 745 generally interfaces with one SGSN 732. Also, the SGSN 732 is optionally connected with the HLR 751 through an SS7-based interface using GPRS enhanced Mobile Application Part (MAP) or with the MSC 749 through an SS7-based interface using Signaling Connection Control Part (SCCP). The SGSN/HLR interface allows the SGSN 732 to provide location updates to the HLR 751 and to retrieve GPRS-related subscription information within the SGSN service area. The SGSN/MSC interface enables coordination between circuit-switched services and packet data services such as paging a subscriber for a voice call. Finally, the SGSN 732 interfaces with a SMSC 753 to enable short messaging functionality over the network 750.

The GGSN 734 is the gateway to external packet data networks, such as the Internet 713 or other private customer networks 755. The network 755 comprises a Network Management System (NMS) 757 linked to one or more databases 759 accessed through a PDSN 761. The GGSN 734 assigns Internet Protocol (IP) addresses and can also authenticate users acting as a Remote Authentication Dial-In User Service host. Firewalls located at the GGSN 734 also perform a firewall function to restrict unauthorized traffic. Although only one GGSN 734 is shown, it is recognized that a given SGSN 732 may interface with one or more GGSNs 734 to allow user data to be tunneled between the two entities as well as to and from the network 750. When external data networks initialize sessions over the GPRS network 750, the GGSN 734 queries the HLR 751 for the SGSN 732 currently serving a MS 741.

The BTS 747 and BSC 745 manage the radio interface, including controlling which Mobile Station (MS) 741 has access to the radio channel at what time. These elements essentially relay messages between the MS 741 and SGSN 732. The SGSN 732 manages communications with an MS 741, sending and receiving data and keeping track of its location. The SGSN 732 also registers the MS 741, authenticates the MS 741, and encrypts data sent to the MS 741.

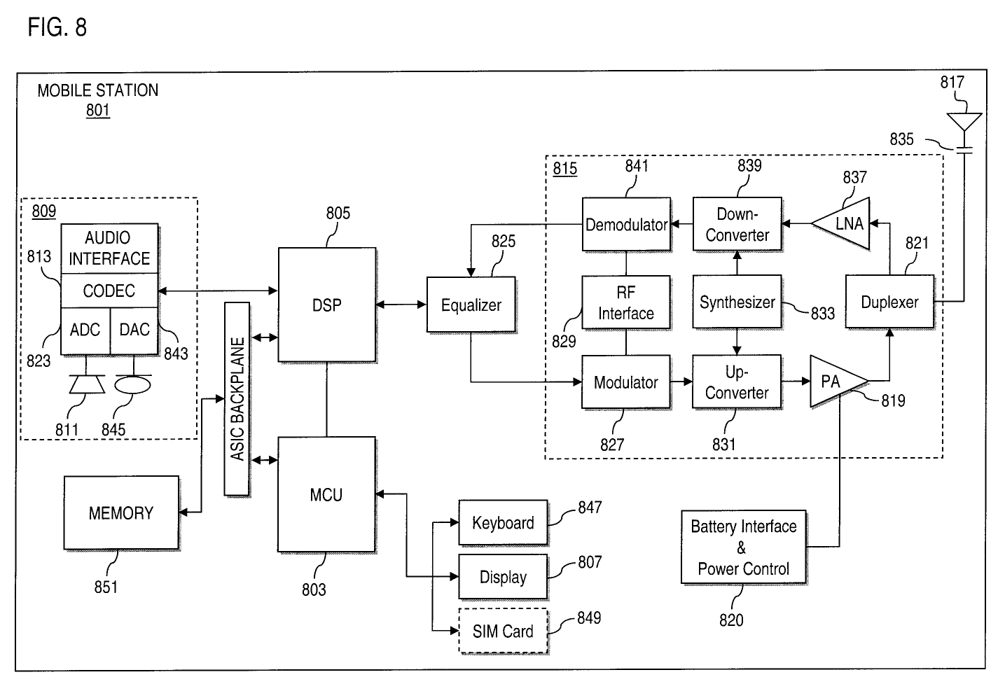

FIG. 8 is a diagram of exemplary components of a mobile station (e.g., handset) capable of operating in the systems of FIGS. 7A and 7B, according to an embodiment of the invention. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 803, a Digital Signal Processor (DSP) 805, and a receiver/transmitter unit including a microphone gain control unit and a speaker gain control unit. A main display unit 807 provides a display to the user in support of various applications and mobile station functions. An audio function circuitry 809 includes a microphone 811 and microphone amplifier that amplifies the speech signal output from the microphone 811. The amplified speech signal output from the microphone 811 is fed to a coder/decoder (CODEC) 813.

A radio section 815 amplifies power and converts frequency in order to communicate with a base station, which is included in a mobile communication system (e.g., systems of FIGS. 7A or 7B), via antenna 817. The power amplifier (PA) 819 and the transmitter/modulation circuitry are operationally responsive to the MCU 803, with an output from the PA 819 coupled to the duplexer 821 or circulator or antenna switch, as known in the art. The PA 819 also couples to a battery interface and power control unit 820.

In use, a user of mobile station 801 speaks into the microphone 811 and his or her voice along with any detected background noise is converted into an analog voltage. The analog voltage is then converted into a digital signal through the Analog to Digital Converter (ADC) 823. The control unit 803 routes the digital signal into the DSP 805 for processing therein, such as speech encoding, channel encoding, encrypting, and interleaving. In the exemplary embodiment, the processed voice signals are encoded, by units not separately shown, using the cellular transmission protocol of Code Division Multiple Access (CDMA), as described in detail in the Telecommunication Industry Association's TIA/EIA/IS-95-A Mobile Station-Base Station Compatibility Standard for Dual-Mode Wideband Spread Spectrum Cellular System; which is incorporated herein by reference in its entirety.

The encoded signals are then routed to an equalizer 825 for compensation of any frequency-dependent impairments that occur during transmission though the air such as phase and amplitude distortion. After equalizing the bit stream, the modulator 827 combines the signal with a RF signal generated in the RF interface 829. The modulator 827 generates a sine wave by way of frequency or phase modulation. In order to prepare the signal for transmission, an up-converter 831 combines the sine wave output from the modulator 827 with another sine wave generated by a synthesizer 833 to achieve the desired frequency of transmission. The signal is then sent through a PA 819 to increase the signal to an appropriate power level. In practical systems, the PA 819 acts as a variable gain amplifier whose gain is controlled by the DSP 805 from information received from a network base station. The signal is then filtered within the duplexer 821 and optionally sent to an antenna coupler 835 to match impedances to provide maximum power transfer. Finally, the signal is transmitted via antenna 817 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 801 are received via antenna 817 and immediately amplified by a low noise amplifier (LNA) 837. A down-converter 839 lowers the carrier frequency while the demodulator 841 strips away the RF leaving only a digital bit stream. The signal then goes through the equalizer 825 and is processed by the DSP 805. A Digital to Analog Converter (DAC) 843 converts the signal and the resulting output is transmitted to the user through the speaker 845, all under control of a Main Control Unit (MCU) 803—which can be implemented as a Central Processing Unit (CPU) (not shown).

The MCU 803 receives various signals including input signals from the keyboard 847. The MCU 803 delivers a display command and a switch command to the display 807 and to the speech output switching controller, respectively. Further, the MCU 803 exchanges information with the DSP 805 and can access an optionally incorporated SIM card 849 and a memory 851. In addition, the MCU 803 executes various control functions required of the station. The DSP 805 may, depending upon the implementation, perform any of a variety of conventional digital processing functions on the voice signals. Additionally, DSP 805 determines the background noise level of the local environment from the signals detected by microphone 811 and sets the gain of microphone 811 to a level selected to compensate for the natural tendency of the user of the mobile station 801.

The CODEC 813 includes the ADC 823 and DAC 843. The memory 851 stores various data including call incoming tone data and is capable of storing other data including music data received via, e.g., the global Internet. The software module could reside in RAM memory, flash memory, registers, or any other form of writable storage medium known in the art. The memory device 851 may be, but not limited to, a single memory, CD, DVD, ROM, RAM, EEPROM, optical storage, or any other non-volatile storage medium capable of storing digital data.

An optionally incorporated SIM card 849 carries, for instance, important information, such as the cellular phone number, the carrier supplying service, subscription details, and security information. The SIM card 849 serves primarily to identify the mobile station 801 on a radio network. The card 849 also contains a memory for storing a personal telephone number registry, text messages, and user specific mobile station settings.

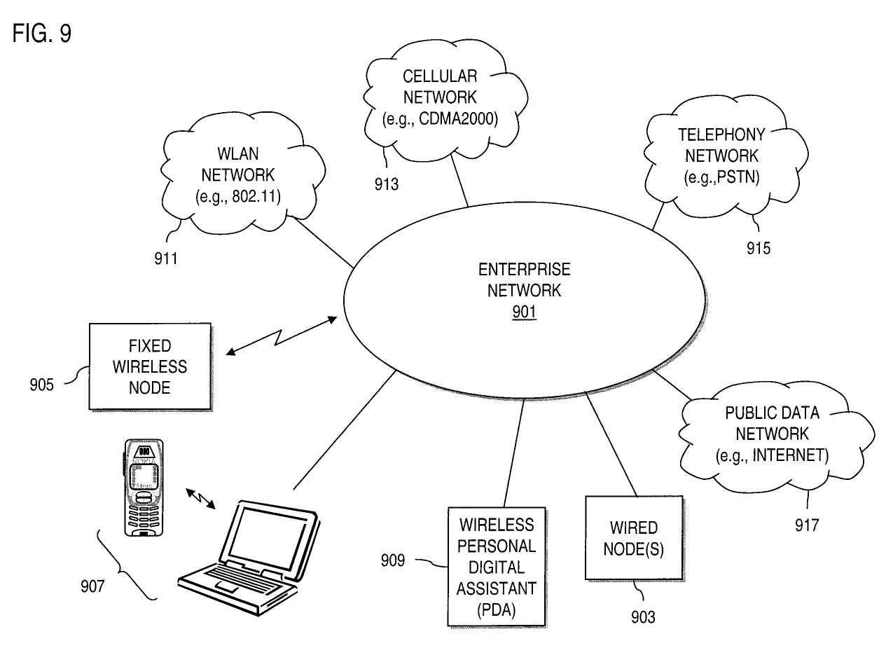

FIG. 9 shows an exemplary enterprise network, which can be any type of data communication network utilizing packet-based and/or cell-based technologies (e.g., Asynchronous Transfer Mode (ATM), Ethernet, IP-based, etc.). The enterprise network 901 provides connectivity for wired nodes 903 as well as wireless nodes 905, 907 and 909 (fixed or mobile), which are each configured to perform the processes described above. The enterprise network 901 can communicate with a variety of other networks, such as a WLAN network 911 (e.g., IEEE 802.11), a cdma2000 cellular network 913, a telephony network 915 (e.g., PSTN), or a public data network 917 (e.g., Internet).

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
receiving data over a communication link;
determining condition of the communication link; and
determining treatment of acknowledgement signaling based on the determined link condition, wherein the treatment includes skipping or discarding acknowledgement signaling.

2. A method according to claim 1, wherein the step of determining the treatment includes determining whether a link condition threshold is satisfied.

3. A method according to claim 2, further comprising:
dynamically adjusting the threshold based on a throughput value associated with the communication link.

4. A method according to claim 1, further comprising:
generating an acknowledgement message in response to the received data, wherein the treatment includes,
waiting for the link condition to change to transmit the acknowledgement message,
utilizing a protocol layer lower than a transport layer protocol employed in transmission of the data for dropping the acknowledgement message, and
receiving a signal from the lower protocol layer to discard the acknowledgement message.

5. A method according to claim 4, wherein the transport layer protocol includes Transmission Control Protocol (TCP).

6. A method according to claim 1, wherein the link condition is determined from buffer length and estimated delay associated with a protocol layer lower than a transport layer protocol employed in transmission of the data.

7. A method according to claim 1, wherein the communication link is established over a radio network.

8. An apparatus comprising:
an adaptive acknowledgement module configured to determine condition of a communication link in response to receiving data over the communication link,
wherein the adaptive acknowledgement module configured to determine treatment of acknowledgement signaling based on the determined link condition, the treatment including skipping or omitting acknowledgement signaling.

9. An apparatus according to claim 8, wherein the adaptive acknowledgement module is further configured to determine the treatment by determining whether a link condition threshold is satisfied.

10. An apparatus according to claim 9, wherein the adaptive acknowledgement module is further configured to dynamically adjust the threshold based on a throughput value associated with the communication link.

11. An apparatus according to claim 8, wherein the adaptive acknowledgement module is further configured to generate an acknowledgement message in response to the received data, wherein the treatment includes,
waiting for the link condition to change to transmit the acknowledgement message,
utilizing a protocol layer lower than a transport layer protocol employed in transmission of the data for dropping the acknowledgement message, or
receiving a signal from the lower protocol layer to discard the acknowledgement message.

12. An apparatus according to claim 11, wherein the transport layer protocol includes Transmission Control Protocol (TCP).

13. An apparatus according to claim 8, wherein the link condition is determined from buffer length and estimated delay associated with a protocol layer lower than a transport layer protocol employed in transmission of the data.

14. An apparatus according to claim 13, wherein the communication link is established over a radio network.

15. A system comprising the apparatus of claim 8 and a transceiver configured to receive the data.

16. An apparatus comprising:
means for receiving data over a communication link; and
means for determining condition of the communication link and for determining treatment of acknowledgement signaling based on the determined link condition, wherein the treatment includes skipping or omitting acknowledgement signaling.

17. An apparatus according to claim 16, further comprising:
means for generating an acknowledgement message in response to the received data, wherein the treatment includes,
waiting for the link condition to change to transmit the acknowledgement message,
utilizing a protocol layer lower than a transport layer protocol employed in transmission of the data for dropping the acknowledgement message, or
receiving a signal from the lower protocol layer to discard the acknowledgement message.

18. A method comprising:
transmitting data over a communication link to a receiver, wherein the receiver is configured to determine condition of the communication link and to determine treatment of acknowledgement signaling based on the determined link condition; and
selectively receiving an acknowledgement message in response to the transmitted data, wherein the treatment includes skipping or discarding the acknowledgement message.

19. A method according to claim 18, wherein the determination of the treatment includes determining, by the receiver, whether a link condition threshold is satisfied.

20. A method according to claim 19, wherein the receiver is further configured to dynamically adjust the threshold based on a throughput value associated with the communication link.

21. A method according to claim 18, wherein the treatment includes,
waiting for the link condition to change to transmit the acknowledgement message,
utilizing a protocol layer lower than a transport layer protocol employed in transmission of the data for dropping the acknowledgement message, or
receiving a signal from the lower protocol layer to discard the acknowledgement message.

22. A method according to claim 21, wherein the transport layer protocol includes Transmission Control Protocol (TCP).

23. A method according to claim 18, wherein the link condition is determined from buffer length and estimated delay associated with a protocol layer lower than a transport layer protocol employed in transmission of the data.

24. A method according to claim 18, wherein the communication link is established over a radio network.

25. A method according to claim 18, wherein the communication link is a 1× Evolution Data-Only (or Data-Optimized) link.
